(19) United States
(12) Patent Application Publication
(10) Pub. No.: US 2025/0391622 A1
(43) Pub. Date: Dec. 25, 2025

(54) RELAY

(71) Applicant: FCL Components Limited, Tokyo (JP)

(72) Inventors: Satoshi Matsumoto, Tokyo (JP); Yoshihiro Sakai, Tokyo (JP); Daishi Kitajima, Tokyo (JP); Ryuji Sasaki, Shinagawa-ku (JP)

(21) Appl. No.: 19/194,891

(22) Filed: Apr. 30, 2025

(30) Foreign Application Priority Data
Jun. 21, 2024 (JP) 2024-100478

(51) Int. Cl. H01H 50/54

(52) U.S. Cl. CPC H01H 50/54

(57) ABSTRACT

A relay having high inrush resistance and energization/contact reliability is provided. The relay comprising an electromagnet, a base part at which the electromagnet is positioned, a fixed contact member fixed to the base part, and a movable contact spring supported by the base part and configured to elastically deformed by an operation of the electromagnet. The fixed contact member has a first fixed contact and a second fixed contact. The movable contact spring has a first movable contact opposed to the first fixed contact and a second movable contact opposed to the second fixed contact. A distance along a shape of the movable contact spring from a portion which serves as a fulcrum for elastic deformation of the movable contact spring, to the first movable contact, is longer than a distance along the shape of the movable contact spring from the portion to the second movable contact.

### CROSS-REFERENCE TO RELATED APPLICATIONS

This application is based upon and claims the benefit of priority of the prior Japanese Patent Application No. 2024-100478 filed on Jun. 21, 2024, the entire contents of which are incorporated herein by reference.

### TECHNICAL FIELD

The present disclosure relates to a relay.

### BACKGROUND

A relay (electromagnetic relay) is known in which a movable contact spring member constituting a relay contact part is configured to connect a terminal fixed to a substrate and a contact spring having a movable contact in combination with each other. The contact part includes a movable contact spring member having a movable contact, and a fixed contact member having a fixed contact facing the movable contact, wherein the pair of contacts is responsible for both functions of energization and cutting off of the load.

Materials which constitute the contact parts are properly used according to the purpose and application. For example, when resistance to inrush is important, a contact made of a material having a relatively high melting point and high hardness is used, and when reliability of energization and contact is important, a contact made of a material having a relatively low melting point and low hardness is often used.

### RELATED ART

[Patent Literature 1] JP 2006-059702 A
[Patent Literature 2] JP 2010-176957 A

### SUMMARY

As for the material of the contact, there exists a trade-off based on its properties. For example, a silver-tin-based material with excellent inrush resistance is inferior to a silver-nickel-based material in contact reliability. On the other hand, the silver-nickel-based material having excellent contact reliability has a lower melting point lower than the silver-tin-based material, and thus when an inrush current flows, the contact becomes high temperature and is prone to welding.

Therefore, an excellent relay is desired in both inrush resistance and energization/contact reliability.

One way to solve this problem is to change the direction of the roll marks of the movable terminal. However, when taking into consideration a shape processing required to satisfy the material characteristics and a cost per unit, which is determined by how many movable terminals can be produced from a given area of material, it is difficult to change the direction of the roll marks.

Therefore, there is a need for a relay having a long life by improving the mechanical reliability of the movable terminal having roll marks.

One aspect of the present disclosure is a relay comprising a base block, and a movable terminal positioned in the base block and having roll marks, wherein the movable terminal has: an insertion part inserted into the base block; a movable contact elastically displaceable in a direction generally perpendicular to a direction of the roll marks with the insertion part as a fulcrum; and a plurality of frustums formed on the insertion part and configured to contact the base block.

According to the present disclosure, since the two contact sets can be opened or closed at different timings, it is possible to carry the functions of interruption and energization of the load to separate contact sets, whereby an excellent relay in both inrush resistance and energization/contact reliability can be provided.

### BRIEF DESCRIPTION OF DRAWINGS

FIG. 1 is a perspective view of a relay according to an embodiment;

FIG. 2 is an exploded perspective view of the relay of FIG. 1;

FIG. 3 is a plan view showing a movable contact spring member;

FIG. 4 is a partially enlarged view showing a state in which both first and second contact sets are opened;

FIG. 5 is a view of the state of FIG. 4 from another angle;

FIG. 6 is a partially enlarged view showing a state in which the first contact set is closed and the second contact set is open; and

FIG. 7 is a partially enlarged view showing a state in which both the first and second contact sets are closed.

### DESCRIPTION OF EMBODIMENTS

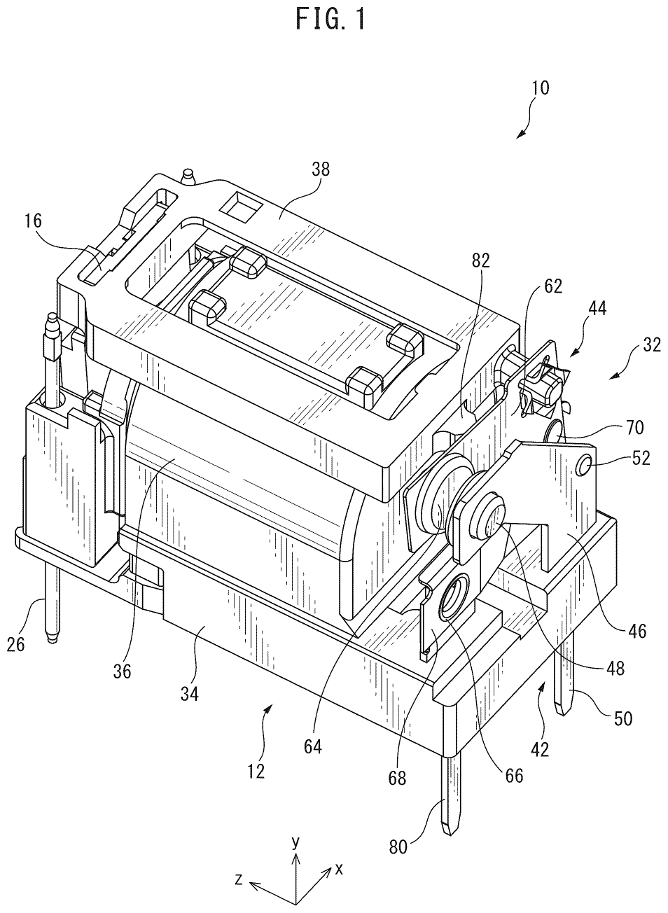

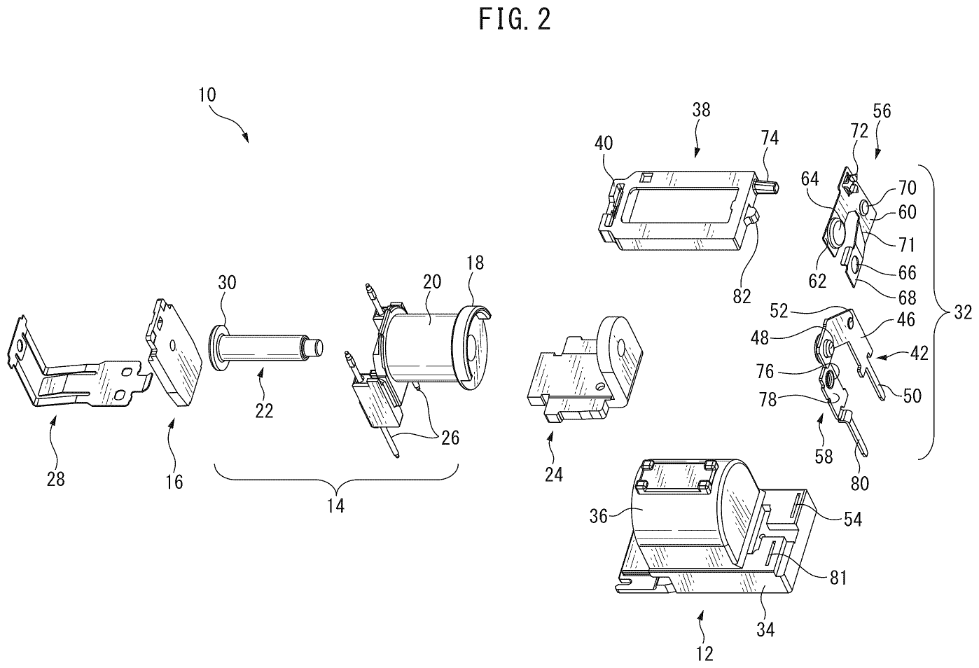

FIG. 1 is a perspective view of a relay 10 according to an embodiment, and FIG. 2 is an exploded perspective view of the relay 10. The relay 10 includes a base unit 12, an electromagnet 14 fixed to the base unit 12, and an armature 16 positioned on one end side of the electromagnet 14 and attracted by a magnetic force generated by an operation of the electromagnet 14. The electromagnet 14 includes an insulating bobbin 18, a coil 20 wound around the bobbin 18, an iron core 22 positioned in the bobbin 18, a yoke 24 having a substantially L-shape connected to one end side of the iron core 22 and configured to form a magnetic circuit in cooperation with the iron core 22, and two coil terminals 26 each having one end connected the coil 20 and the other end connected to an external power source (not shown). The armature 16 is, for example, a flat plate-like member formed of magnetic steel. The armature 16 is elastically displaceably connected to the yoke 24 through a hinge spring 28, and is positioned opposed to a head 30 of the iron core 22. The hinge spring 28 functions as a resilient hinge between the yoke 24 and the armature 16, and by its own spring action, urges the armature 16 away from the head 30 of the iron core 22.

The base unit 12 accommodates the electromagnet 14 and a contact part 32 described later. The base unit 12 includes a base part 34 and a case part 36 for accommodating the electromagnet 14. The base unit 12 may be integrally formed by resin molding, etc. A card 38, which is an example of an actuating member having a recess 40 engaged with the armature 16, is positioned above the case part 36. The card 38 can be displaced in the longitudinal direction parallel to the axial direction of the iron core 22, when the electromagnet 14 is excited or demagnetized. In the present embodiment, for convenience, a forward/backward direction parallel to the axial direction of the iron core 22 is referred to as a z-direction, a width direction perpendicular to the z-direction is referred to an x-direction, and a height direction perpendicular to both the x-direction and the z-direction is referred to as a y-direction.

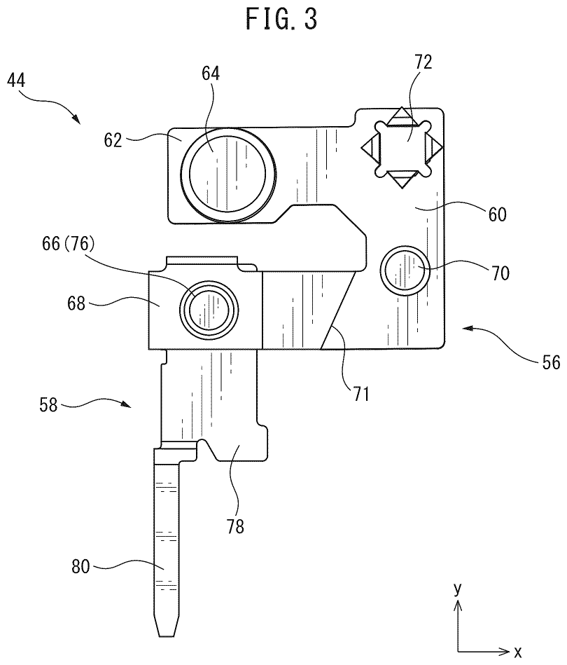

The contact part 32 includes a fixed contact member 42 and a movable contact spring 44 (see FIG. 3 described later). The fixed contact member 42 has a support part 46 having a substantially L-shape, a first fixed contact 48 provided at one end of the support part 46, a terminal part 50 extending from the other end of the support part 46, and a second fixed contact 52 provided at an intermediate portion of the substantially L-shaped. The terminal part 50 is inserted into and fixed to an insertion hole 54 formed in the base part 34 of the base unit 12. In addition, the relay 10 may be configured to fit into the base unit 12, and may have a cover (not shown) which accommodates the above components in cooperation with the base unit 12.

The movable spring 44 has a contact spring 56 and a terminal 58. The contact spring 56 has a generally C-shape, and has an intermediate portion 60, a first end 62 extending from one end of the intermediate portion 60, a first movable contact 64 provided at the first end 62, a second end 68 extending from the other end of the intermediate portion 60 and having a through hole 66 formed therein, and a second movable contact 70 provided at the intermediate portion 60. The second end 68 may be somewhat folded along an angled line 71 inclined relative to the x- or y-direction to cause a torsional action during elastic deformation of the contact spring 56 to improve contactability between the contacts.

The contact spring 56 has a through hole 72 formed by burring processing, etc. When a rod-shaped convex portion 74 of the card 38 is engaged in the through hole 72, the displacement direction of the movable contact due to the displacement of the card 38 is regulated to be substantially along the z-direction, thereby the operation of the relay is stabilized.

The terminal 58 has a tab 78 having a through hole 76 formed by the burring processing, etc., and a terminal part 80 extending downward from the tab 78. The tab 78 is inserted into and fixed to an insertion hole 81 formed in the base part 34 of the base unit 12. By aligning and caulking the through hole 66 and the through hole 76, a movable spring 44 is formed in which the contact spring 56 and the terminal 58 are substantially integrally connected. Although the movable spring 44 of the illustrated example is configured by assembling the contact spring 56 and the terminal 58 to each other, the movable spring 44 may be formed by processing a substantially one piece of material.

The first fixed contact 48 and the first movable contact 64 are opposed to each other and constitute a first contact set, and the second fixed contact 52 and the second movable contact 70 are opposed to each other and constitute a second contact set. Hereinafter, the motion of each contact set will be explained.

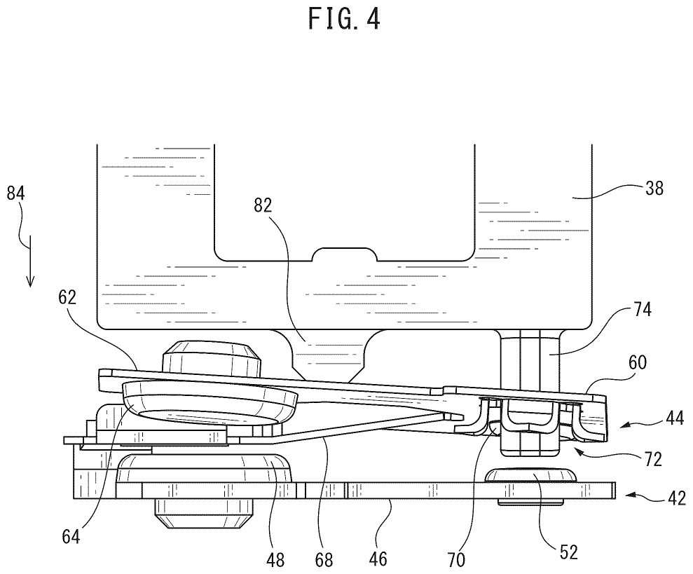

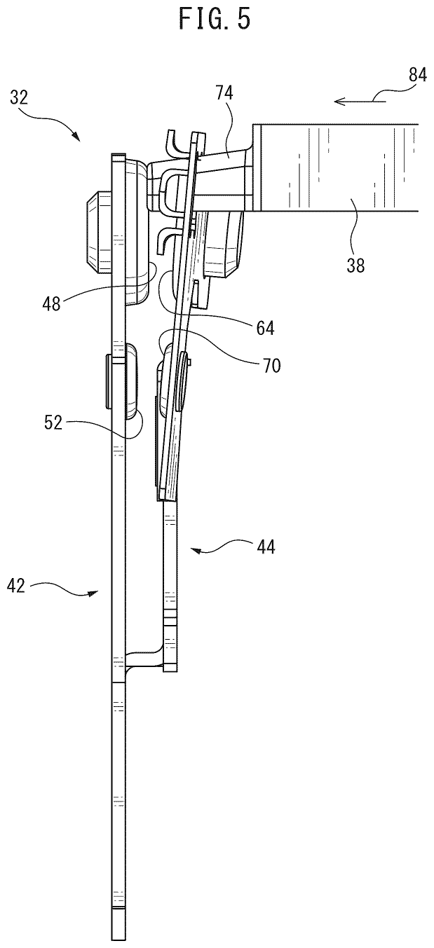

FIG. 4 is a partially enlarged view showing a state in which both the first and second contact sets are opened, and FIG. 5 is a view of the state of FIG. 4 viewed from another angle. The movable spring 44 is elastically deformed by the operation of the electromagnet 14. Specifically, when the card 38 is displaced in the direction of an arrow 84 due to the excitation or demagnetization of the electromagnet 14, a protrusion 82 formed on a z-direction end of the card 38 presses the first end 62 of the movable spring 44 in substantially the z-direction toward the fixed contact member 42. By virtue of this, the contact spring 56 is elastically deformed, and the first movable contact 64 and the second movable contact 70 are elastically displaced toward the first fixed contact 48 and the second fixed contact 52, respectively.

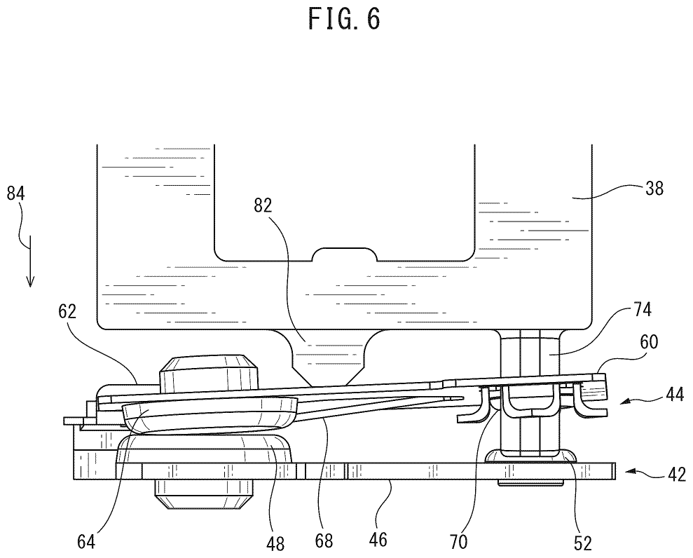

FIG. 6 is a partially enlarged view showing a state in which the first contact set is closed and the second contact set is opened. As shown in FIG. 3, since the second end 68 of the contact spring 56 is connected to the terminal 58 fixed to the base part 34, the movable spring 44 is elastically deformed using the second end 68 as a fulcrum, by being pressed against the card 38. In this regard, the second movable contact 70 is formed on the intermediate portion 60 having one end connected to the second end 68, and the first movable contact 64 is formed on the first end 62 connected to the other end of the intermediate portion 60. Thus, the distance along the C-shaped contact spring 56 from the second end 68, which serves as a fulcrum for the clastic deformation of the contact spring 56, to the first movable contact 64, is longer than the continuous distance along the contact spring 56 from the second end 68 to the second movable contact 70. Therefore, when pressing the specific portion of the movable spring 56 (in this case, the first end 68), an amount of clastic displacement of the first movable contact 64 is larger than that of the second movable contact 70. As a result, as shown in FIG. 6, the first movable contact 64 comes into contact with the first fixed contact 48 so that the first contact set is closed, at this time, the second contact set is still in an open state.

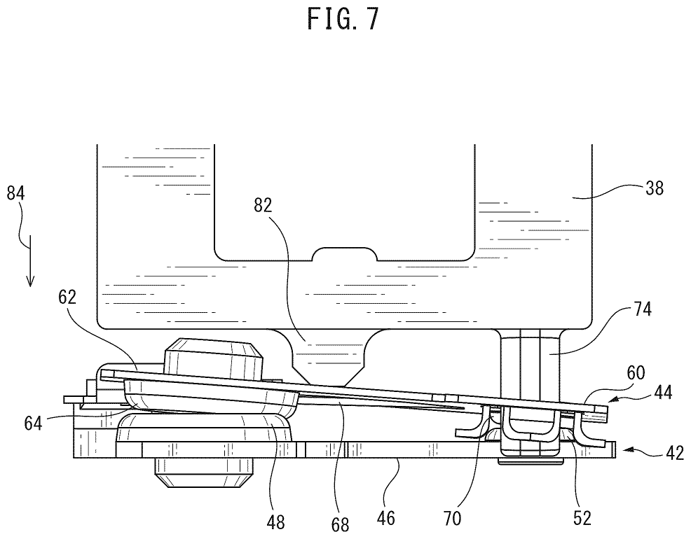

FIG. 7 is a partially enlarged view showing a state in which both the first and second contact sets are closed. From the state of FIG. 6, when the card 38 is displaced further in the direction of the arrow 84, while the closure of the first contact point set is maintained, the second movable contact 70 comes into contact with the second fixed contact 52 so that the second contact set is closed. Further, from the state of FIG. 7, when the card 38 is displaced in the direction opposite to the arrow 84, first the second contact set is opened as shown in FIG. 6, and when the card 38 is further displaced in the direction opposite to the arrow 84, the first contact set is also opened as shown in FIG. 5.

In this way, in the present embodiment, by pressing one portion of the movable spring 44, it is possible to shift the timing of the two contact sets are closed and opened.

In this regard, it is preferable that the first movable contact 64 and the first fixed contact 48 of the first contact set preferably include silver-tin-based material such as AgSnO₂ having high inrush resistance. Since an inrush current flows through the first contact set when it is closed, the silver-tin based material with a relatively high melting point may be used to prevent welding even when the contact point becomes hot, thereby the welding is unlikely to occur and the load can be properly cut off when the contact is made.

On the other hand, it is preferable that the second movable contact 70 and the second fixed contact 52 of the second contact set preferably include silver-nickel-based material such as AgNi having high reliability of energization and contactability. The silver-nickel-based material has a lower melting point and a lower hardness than those of the silver-tin-based material, and thus have higher energization/contact reliability between the contacts. Further, the silver-nickel-based material has a relatively high conductivity, and is also advantageous in terms of heat generation.

According to the present embodiment, the first contact set to be closed first uses the material which emphasizes the inrush resistance, and the second contact set to be closed later uses the material which emphasizes electric conductivity. Therefore, the function of cutting off the load and the function of energization can be performed by the separate contact sets, and the optimum material can be selected for each contact set. Accordingly, it is possible to provide a relay having high inrush resistance and energization/contact reliability.

Further, by arranging the second contact set closer to the second end 68, which functions as the fulcrum of the clastic displacement, than the first contact set, the conductor resistance is reduced, which is advantageous in terms of heat dissipation from the terminal 58 to a substrate (not shown), and it is possible to suppress heat generation in the movable spring 44. Further, it is possible to arrange the first and second contact sets relatively far apart in substantially the same circuit, thereby the first contact set is less susceptible to heat generation due to energization. Therefore, it is expected to improve the inrush resistance and reduce wear, further extending the life of the relay.

What is claimed is:

1. A relay comprising:
an electromagnet;
a base part at which the electromagnet is positioned;
a fixed contact member fixed to the base part; and
a movable contact spring supported by the base part and configured to elastically deformed by an operation of the electromagnet,
wherein the fixed contact member has a first fixed contact and a second fixed contact,
wherein the movable contact spring has a first movable contact opposed to the first fixed contact and a second movable contact opposed to the second fixed contact, and
wherein a distance along a shape of the movable contact spring from a portion which serves as a fulcrum for elastic deformation of the movable contact spring, to the first movable contact, is longer than a distance along the shape of the movable contact spring from the portion to the second movable contact.

2. The relay according to claim 1, wherein the movable contact spring has a contact spring having a generally C-shape and a terminal fixed to the base part, and wherein the contact spring has an intermediate portion having the second movable contact, a first end extending from one end of the intermediate portion and having the first movable contact, and a second end extending from the other end of the intermediate portion and connected to the terminal.

3. The relay according to claim 2, wherein the relay has a card configured to be displaced by the operation of the electromagnet and press the first end.

4. The relay according to claim 1, wherein a material constituting the first movable contact and the first fixed contact has a higher melting point and a higher hardness than those of a material constituting the second movable contact and the second fixed contact.

5. The relay according to claim 4, wherein the material constituting the first movable contact and the first fixed contact includes a silver-tin-based material.

6. The relay according to claim 4, wherein the material constituting the second movable contact and the second fixed contact includes a silver-nickel-based material.
